(19) United States
(12) Patent Application Publication
(10) Pub. No.: US 2010/0251376 A1
(43) Pub. Date: Sep. 30, 2010

(54) METHODOLOGIES, TOOLS AND PROCESSES FOR THE ANALYSIS OF INFORMATION ASSURANCE THREATS WITHIN MATERIAL SOURCING AND PROCUREMENT

(75) Inventor: Lon Daniel McPhail, San Diego, CA (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: KUITY CORP, San Diego, CA (US)

(21) Appl. No.: 12/749,424

(22) Filed: Mar. 29, 2010

Related U.S. Application Data
(60) Provisional application No. 61/164,374, filed on Mar. 27, 2009.

(51) Int. Cl. G06F 11/30; G06Q 30/00

(52) U.S. Cl. 726/25; 715/700; 707/756

(57) ABSTRACT

Enterprise resource planning systems and methods are described. Point sources for at-risk components and technologies in an enterprise are assembled, identified and localized by identifying factors such as geo-political affiliation of parties including employers, employees, organizations, education levels of the parties, capability and abilities to create or modify malware, and the financial level of the per-capita population model-based threat rankings. Threats to a pipeline are determined, ranked, and a targeted risk mitigation prioritization plan against identified high-level threats is created.

### CROSS-REFERENCE TO RELATED APPLICATIONS

The present Application claims priority from U.S. Provisional Patent Application No. 61/164,374 filed Mar. 27, 2009, which is incorporated by reference herein in its entirety.

### BACKGROUND OF THE INVENTION

1. Field of the Invention

The present invention relates generally to sourcing threat analysis and more particularly to the identifying, assessing and advising of current and projected geo-political threats to information technology materials enterprises.

2. Description of Related Art

Publishers of software products and manufacturers of electronic components and devices often use complex, multinational supply chains. Subcomponents of consumer electronics, fully integrated products and distributable software (e.g. distributions on BluRay, DVD and CD ROMs) may be produced by combinations of employees, sub-contractors and third parties. Accordingly, many opportunities arise to embed malware in electronic products. For example, a processor board of a smart phone may be produced in a first country, programmed using a device manufactured in a second country and assembled and shipped from a third country, each of these operations being performed under contract. For example, it would be very difficult to detect malware embodied in a Flash memory that has a modified version of a communications device driver used in a wireless device that enables trap door access to software and data stored by a purchaser of the device. It is difficult for an Enterprise to detect or anticipate compromised electronic products using conventional systems and methods.

### BRIEF SUMMARY OF THE INVENTION

Certain embodiments of the present invention provide systems and methods employing methodologies, tools and processes used for the analysis of information assurance threats within material sourcing and procurement.

### BRIEF DESCRIPTION OF THE DRAWINGS

FIG. 1 is a chart depicting an example of a process objective description.

FIG. 2 shows an example of a threat model considerations matrix.

FIG. 3 graphically depicts the balance between engineering capabilities and motivations of an engineer to create malware.

FIG. 4 provides an example of a cross-index between engineering capabilities and economic motivations.

FIG. 5 includes a chart showing an example of historical performance.

FIG. 6 shows a high-level process for a sourcing threat analysis.

FIG. 7 is an architecture drawing describing an example of high-level data flow processes.

FIG. 8 shows an example of functional process flow of a core threat model.

FIG. 9 depicts a threat model high-level architecture description according to certain aspects of the invention.

FIG. 10 is a simplified block schematic illustrating a processing system employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention.

In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration. For the purposes of this description, information assurance (“IA”) refers to the field in which threats to data processing and to the data itself are considered. For the purposes of this description, malware refers to a component of hardware or software which results in an unwanted and unwelcomed action by information technology assets.

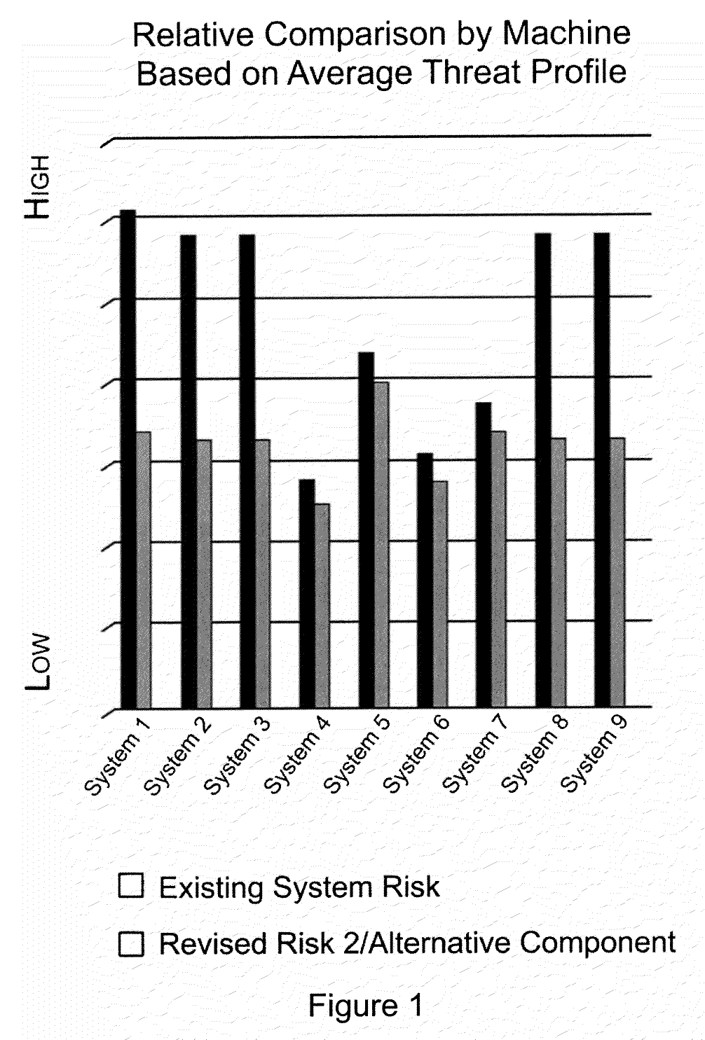

Certain embodiments of the invention provide sourcing threat analysis which will identify, assess, and advise of the current and projected geo-political threats to the enterprise of customer information technology materials. FIG. 1 includes a chart depicting an example of a relative comparison identified by machine based on an average threat profile. According to certain aspects of the invention, a threat assessment of computing systems comprises analyzing hardware and software components based on a plurality of factors. The analysis evaluates risk in terms of financial loss, delay and convenience. Financial loss can be used to quantify the financial exposure of an enterprise to malware related damages and the increased costs to the enterprise for increased malware screening costs. The analysis may address prioritization of phase-out and replacement candidates for both hardware and software components. Accordingly, threat assessments may influence purchasing decision and be used to identify alternative components for reducing malware risks. Analyses can assist the understanding of current malware risk state and identify approaches to ameliorate the risk. Thus, corporate and/or organizational security can be strengthened and rational management of risk in purchase/replacement processes can be facilitated.

Certain embodiments of the invention provide systems, methods, processes, and tools for determining one or more information assurance threats. In certain embodiments, one or more discrete strategic capabilities are enabled. Strategic capabilities may include identification and localization of point sources for at-risk components and technologies in an enterprise. Strategic capabilities may include the identification of one or more factors using a source-related model, including:
geo-political affiliation and motives of an employer, employees, organizations
education levels of persons associated with the enterprise
skills and capability of persons associated with the enterprise, such as ability to create and/or modify malware
the financial level of the per-capita population model-based threat rankings.
other threats from individuals and organizations other-than-National threat vectors.
   Strategic capabilities may include determination of threats to an enterprise via Information Technology material. Strategic capabilities may include ranking threats against Information Technology material. Strategic capabilities may include creation of a targeted risk mitigation prioritization plan against identified high-level threats.

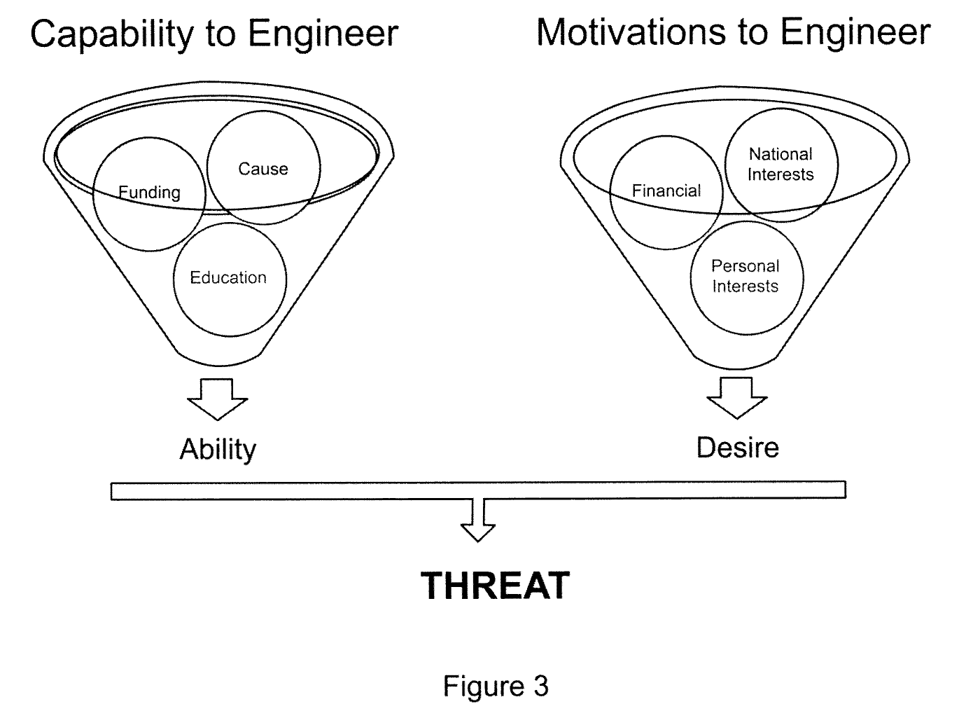

Certain embodiments of the invention can reduce all IA-related material to constituent sub-components, and can then trace those sub-components through the enterprise to determine the origin of each sub-component. Origins may be examined for probability of risk realization based on the source-related factors described above and also based upon functions, interests, and groupings such as those depicted in FIG. 3.

Certain embodiments comprise systems and methods configured according to an execution methodology. For the purpose of this description, a serialized work-flow description of the methodology is provided according to certain aspects of the invention. Accordingly, certain major actions and steps are described to provide insight into the enterprise for intended actions.

In certain embodiments, a system may be configured to obtain and maintain an enterprise inventory. The inventory typically identifies components capable of housing malware. Each inventory line-item may be broken down to identify memory storage capable hardware and software sub-components. Such sub-components can be isolated and identified for analysis.

The method may also comprise steps for determining the origin of all isolated sub-components capable of becoming a malware vector. The ability of such material sources to generate a threat may be determines and quantified. Typically, a step of calculating probability follows to obtain the probability that adequate motive exists for that material source to generate a threat. Probability can determined through the application of the multi-factor source-related model described above. The threat may be determined by examining past malware performance together with current and anticipated motives of the material source.

In one step, various interests of each material source are analyzed, wherein the interests include those of the corporation, geo-political orientation of the source facility and of the controlling principles. It will be appreciated that the latter analysis may employ a model that can be a sub-component of the multi-factored, source-related model described above.

The impact, or lack of impact, of the factors determined from the multi-factored, source-related model on the threat probability can be determined for each material source. This latter determination may use the multi-factored, source-related model described above. Threat probability can be determined by the combination of the multi-factored model described above against an available dataset representing enterprise materials. Subsequently, the output of this model will typically be rank-ordered and prioritized to create a 1-n threat probability report of enterprise materials.

Given the 1-n threat probability report as described above, for those material sources found to have a high-enough probability of threat, actionable mitigation steps can be determined for each significant threat found. A mitigation recommendation can be provided for all material groupings, and actionable mitigation steps for all threat probabilities considered by the enterprise to be a Threat of Interest (TOI) may be disseminated.

Certain embodiments employ a methodology that comprises a process that includes a plurality of steps that can include an analysis of certain orientation markers. One process step is directed to gathering and reviewing existing information including source data and procured materials. In another step, key personnel may be interviewed. Another step includes identifying variables and risk factors which include review and consideration of use of third party sources. In some embodiments, a database structure may be configured based on organizational needs, operations and structure, whereby the database receives and maintains the historical information. A model may be constructed and the historical information can be imported into the model. Threat potentials may be sized and ranked. A series of optionally iterative steps may be performed to validate and refine the model in order to produce a reportable output.

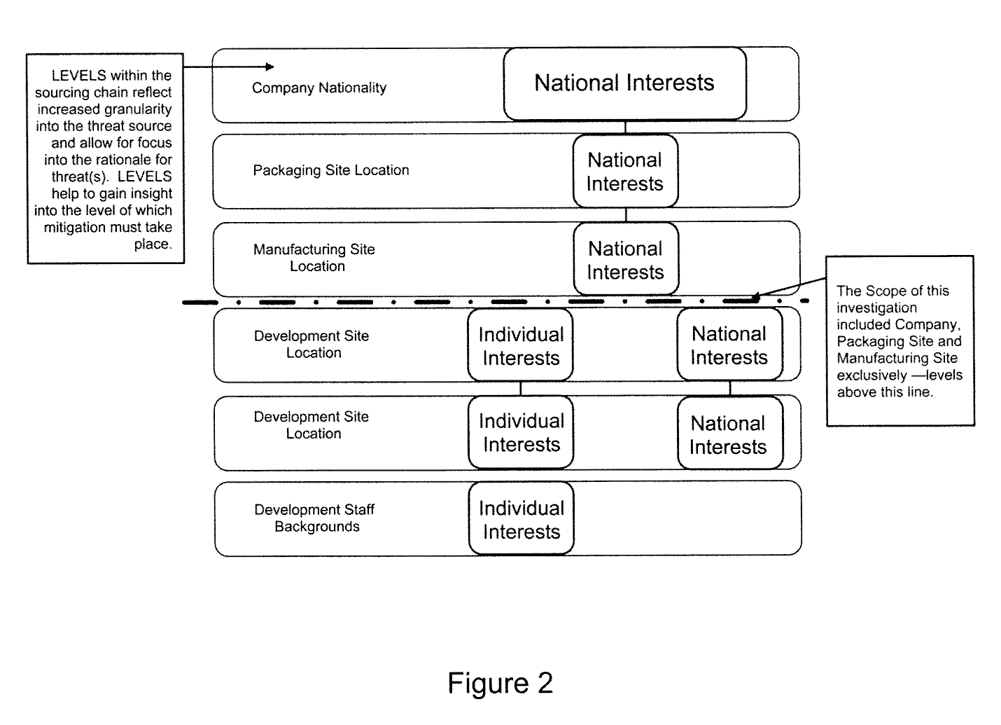

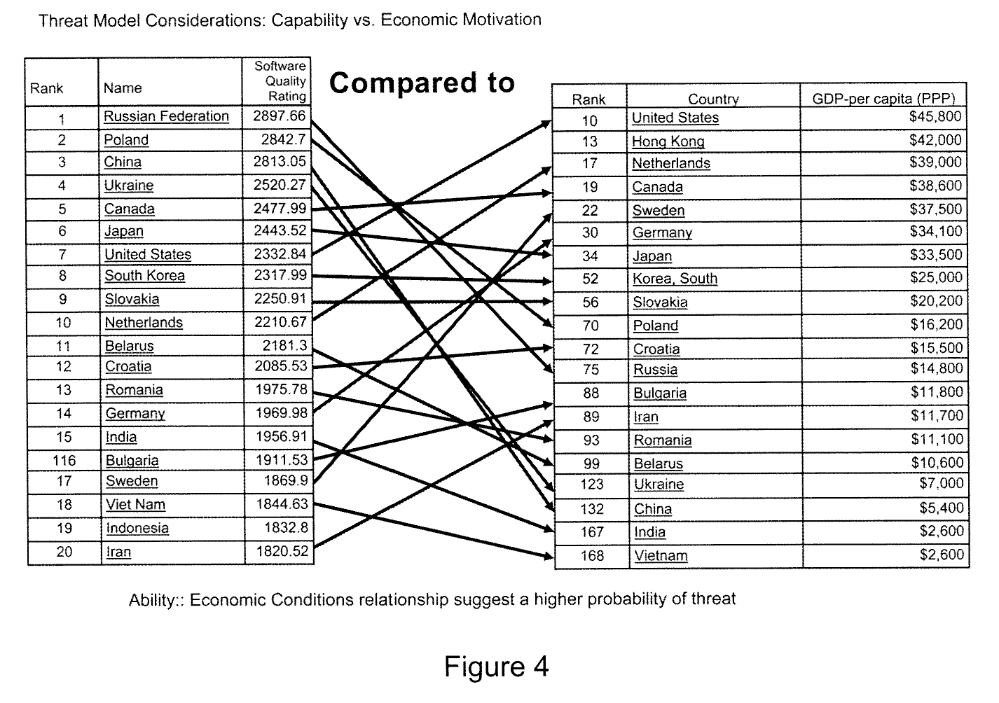

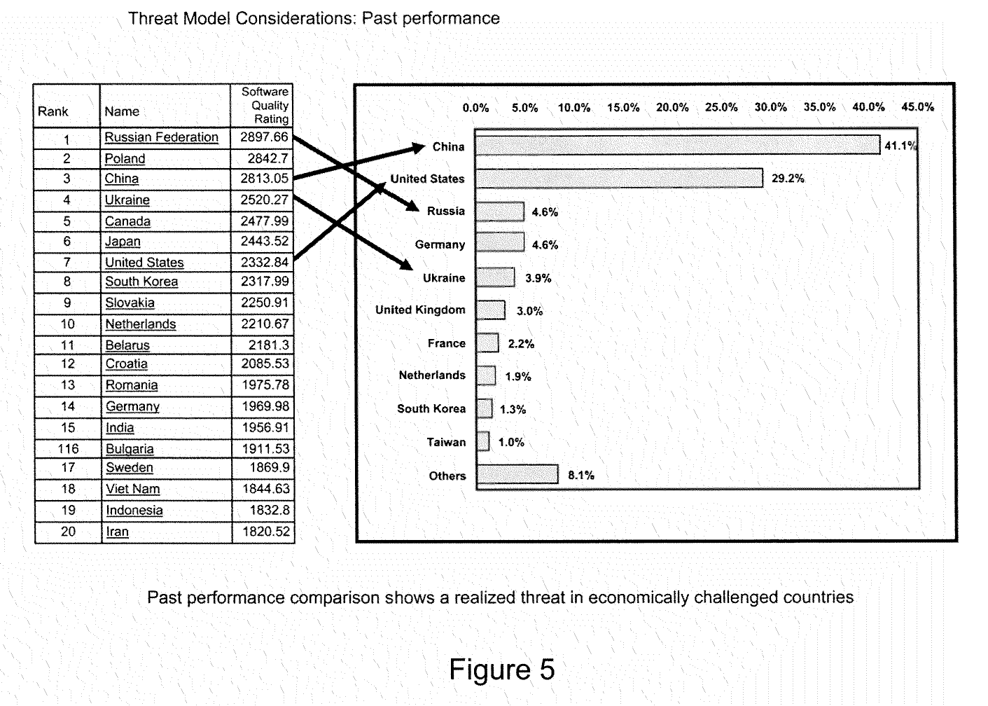

FIG. 2 shows a simplified block diagram of an example of a threat model considerations matrix. It will be appreciated that the number of levels in the sourcing chain can vary based on the nature and quantity of components, steps in manufacturing the components and complexity of manufacture. Turning to FIG. 3, the depiction of balance between engineering capabilities and motivations of an engineer illustrate graphically the driving forces behind malware creation. The quantification of these forces can be performed using statistical information including, for example, demographic and other metrics such as those shown in FIG. 4. FIG. 5 provides an example of historical performance information that may be assessed in one or more steps. The chart depicts the relative proportions of malware hosting by country. By way of comparison, the software quality rating associated with various countries is provided.

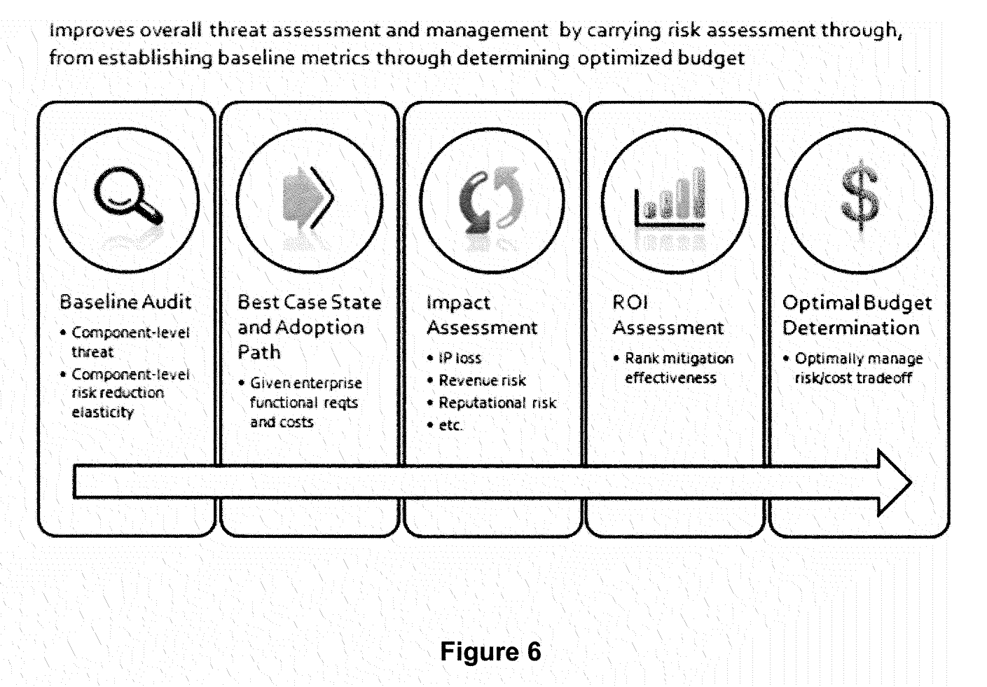

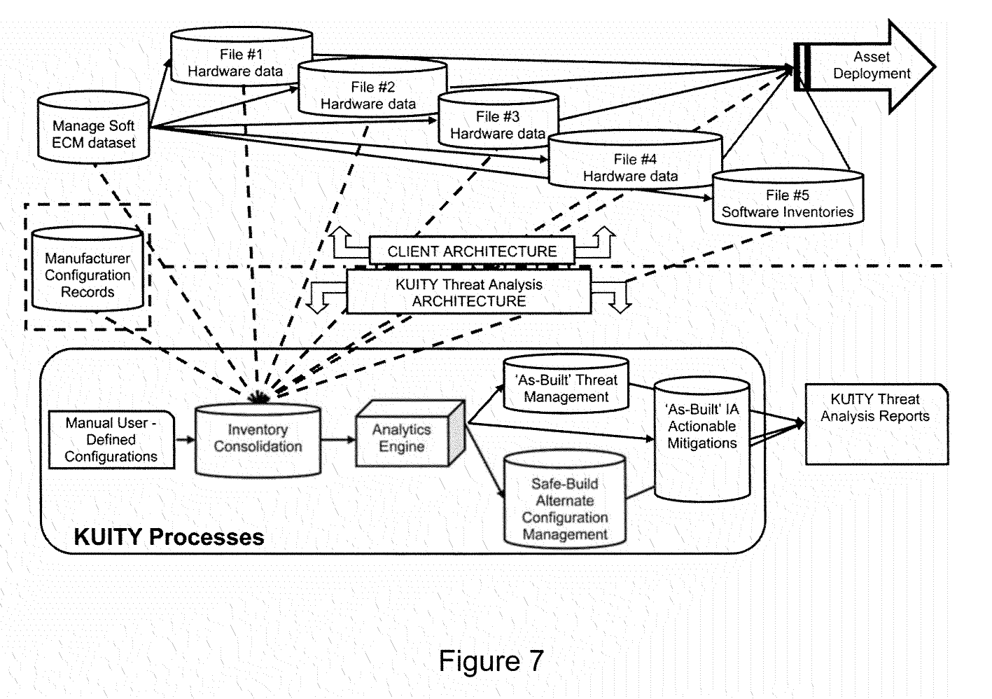

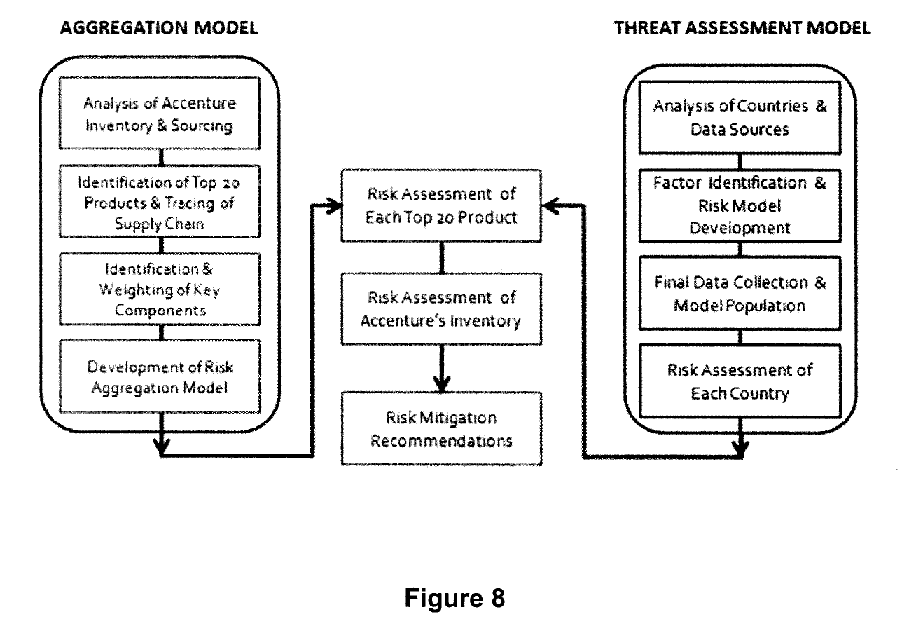

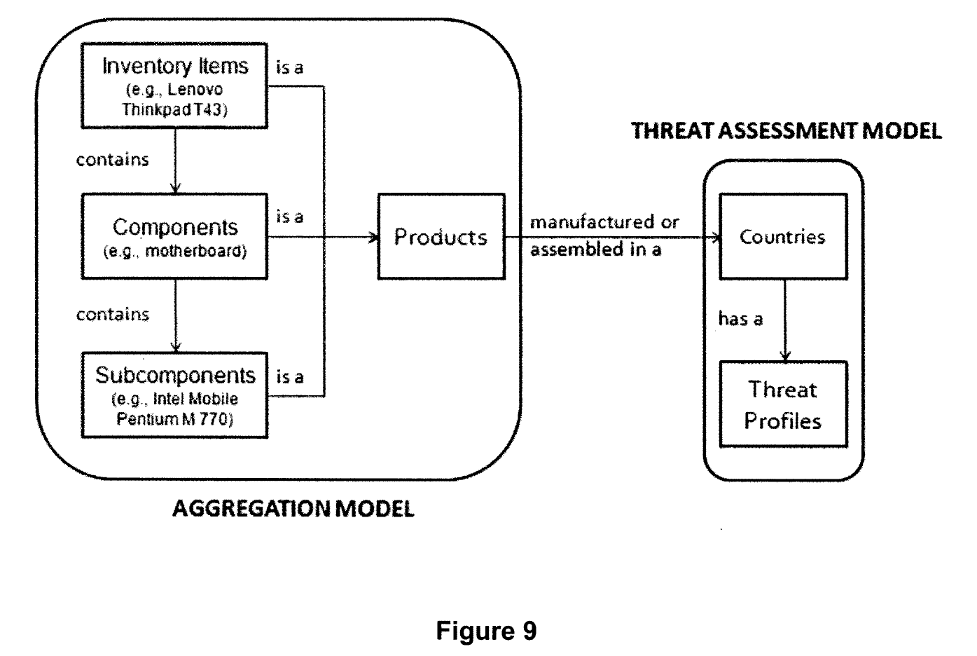

In FIG. 6, a high-level process for sourcing threat analysis is depicted while FIG. 7 shows a generalized system architecture and describes one example of a high-level data flow processes. FIG. 8 shows an example of functional process flow of a core threat model and FIG. 9 depicts one example of a threat model high-level architecture description according to certain aspects of the invention.

According to certain aspects of the invention, a sourcing threat assessment model identifies and localizes point sources for at-risk components and technologies inside an enterprise, identifies factors for multi-factorial model threat rankings, determines threats to that enterprise, ranks threats, and enables targeted risk mitigation prioritization plan against identified threats.

### System Description

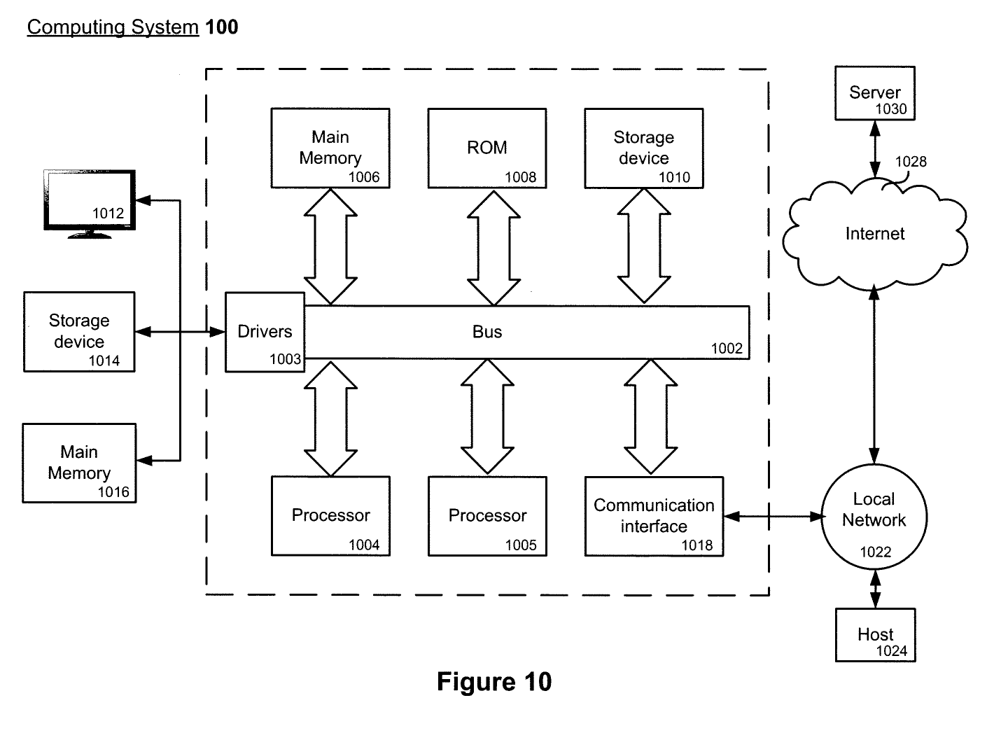

Turning now to FIG. 10, certain embodiments of the invention employ a processing system that includes at least one computing system 100 deployed to perform certain of the steps described above. Computing systems may be a commercially available system that executes commercially available operating systems such as Microsoft Windows®, UNIX or a variant thereof, Linux, a real time operating system and or a proprietary operating system. The architecture of the computing system may be adapted, configured and/or designed for integration in the processing system, for embedding in one or more of an image capture system, a manufacturing/machining system, a graphics processing workstation and/or test stations. Generally, computing system 100 comprises a bus 1002 and/or other mechanisms for communicating between processors, whether those processors are integral to the computing system 100 (e.g. 1004, 1005) or located in different, perhaps physically separated computing systems 100. Device drivers 1003 may provide output signals used to control internal and external components

Computing system 100 also typically comprises memory 1006 that may include one or more of random access memory (“RAM”), static memory, cache, flash memory and any other suitable type of storage device that can be coupled to bus 1002. Memory 1006 can be used for storing instructions and data that can cause one or more of processors 1004 and 1005 to perform a desired process. Main memory 1006 may be used for storing transient and/or temporary data such as variables and intermediate information generated and/or used during execution of the instructions by processor 1004 or 1005. Computing system 100 also typically comprises non-volatile storage such as read only memory (“ROM”) 1008, flash memory, memory cards or the like; non-volatile storage may be connected to the bus 1002, but may equally be connected using a high-speed universal serial bus (USB), Firewire or other such bus that is coupled to bus 1002. Non-volatile storage can be used for storing configuration, and other information, including instructions executed by processors 1004 and/or 1005. Non-volatile storage may also include mass storage device 1010, such as a magnetic disk, optical disk, flash disk that may be directly or indirectly coupled to bus 1002 and used for storing instructions to be executed by processors 1004 and/or 1005, as well as other information.

Computing system 100 may provide an output for a display system 1012, such as an LCD flat panel display, including touch panel displays, electroluminescent display, plasma display, cathode ray tube or other display device that can be configured and adapted to receive and display information to a user of computing system 100. Typically, device drivers 1003 can include a display driver, graphics adapter and/or other modules that maintain a digital representation of a display and convert the digital representation to a signal for driving a display system 1012. Display system 1012 may also include logic and software to generate a display from a signal provided by system 1000. In that regard, display 1012 may be provided as a remote terminal or in a session on a different computing system 100. For example, an analysis of a device under test may be performed at a test station where inputs to the device are stimulated and outputs measured and results presented graphically to an operator. Patterns of response that correspond to expected, rated and/or specified responses may be considered free of malware. However, abnormal behavior or behavior previously associated with a harmful modification of hardware (or software) may indicate undesired modification of the device under test.

An input device 1014 is generally provided locally or through a remote system and typically provides for alphanumeric input as well as cursor control 1016 input, such as a mouse, a trackball, etc. It will be appreciated that input and output can be provided to a wireless device such as a PDA, a tablet computer or other system suitable equipped to display the images and provide user input.

According to one embodiment of the invention, certain analyses and processes may be performed by computing system 100. Processor 1004 executes one or more sequences of instructions. For example, such instructions may be stored in main memory 1006, having been received from a computer-readable medium such as storage device 1010. Execution of the sequences of instructions contained in main memory 1006 causes processor 1004 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 1004 and/or 1005, particularly where the instructions are to be executed by processor 1004 and/or 1005 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 1004 and 1005 or remotely, typically by use of network connection. Non-volatile storage may be removable from computing system 1004, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 100. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 1004 and/or 1005. For example, the instructions may initially be retrieved from a magnetic disk of a remote computer and transmitted over a network or modem to computing system 100. The instructions may optionally be stored in a different storage or a different part of storage prior to or during execution.

Computing system 100 may include a communication interface 1018 that provides two-way data communication over a network 1020 that can include a local network 1022, a wide area network or some combination of the two. For example, an integrated services digital network (ISDN) may used in combination with a local area network (LAN). In another example, a LAN may include a wireless link. Network link 1020 typically provides data communication through one or more networks to other data devices. For example, network link 1020 may provide a connection through local network 1022 to a host computer 1024 or to a wide are network such as the Internet 1028. Local network 1022 and Internet 1028 may both use electrical, electromagnetic or optical signals that carry digital data streams.

Computing system 100 can use one or more networks to send messages and data, including program code and other information. In the Internet example, a server 1030 might transmit a requested code for an application program through Internet 1028 and may receive in response a downloaded application that provides for the anatomical delineation described in the examples above. The received code may be executed by processor 1004 and/or 1005.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for analyzing security threats in an enterprise. In some of these embodiments, the method is implemented in a computer system comprising one or more processors configured to execute one or more computer program modules. In some of these embodiments, the method comprises executing, on the one or more processors of the computer system, one or more computer program modules configured to obtain information associated with a malware risk to an enterprise system. In some of these embodiments, the method comprises executing, on the one or more processors of the computer system, one or more computer program modules configured to provide assurance threat analysis intelligence corresponding to the information by determining relationships between portions of the information. In some of these embodiments, the method comprises executing, on the one or more processors of the computer system, one or more computer program modules configured to generate a visualization of threats to the enterprise system based on the intelligence an the results from performed analytics on the information and the intelligence. In some of these embodiments, the visualization includes a display of one or more reports.

Certain embodiments of the invention provide systems and methods for threat identification and analysis. Some of these embodiments comprise obtaining information associated with an enterprise from a plurality of sources. Some of these embodiments comprise transforming the information to obtain formatted data. Some of these embodiments comprise orchestrating the formatted data. Some of these embodiments comprise determining relationships between portions of the formatted data to obtain information assurance threat analysis intelligence related to the enterprise. Some of these embodiments comprise performing a plurality of analytics on the formatted data and information assurance threat analysis intelligence. In some of these embodiments, results of the determining relationships and performing analytics steps are provided to a visualizer configured to produce one or more reports to the user.

In some of these embodiments, the enterprise system is comprised of one or more information technology materials tracking systems. In some of these embodiments, the enterprise system is a sourcing system. In some of these embodiments, the enterprise system is a purchasing system. In some of these embodiments, the enterprise system is an inventory control system. In some of these embodiments, the plurality of sources includes data sources external to the enterprise. In some of these embodiments, the step of transforming the information includes categorizing and sorting the information before transforming the information to a predetermined data format. In some of these embodiments, the information is obtained and stored using one or more of an SQL call and formatted and unformatted data calls from formatted and unformatted datasets. In some of these embodiments, the information is either received from, or supplied by, a method which automates the data exchange with one or more data sources.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
obtaining information associated with malware risk to an enterprise system;
providing assurance threat analysis intelligence corresponding to the information by determining relationships between portions of the information; and
generating a visualization of threats to the enterprise system based on the intelligence an the results from performed analytics on the information and the intelligence,
wherein the visualization includes a display of one or more reports.

2. The method of claim 1, wherein the enterprise system comprises one or more information technology materials tracking systems.

3. The method of claim 1, wherein the enterprise system comprises a sourcing system.

4. The method of claim 1, wherein the enterprise system comprises a purchasing system.

5. The method of claim 1, wherein the enterprise system comprises an inventory control system.

6. The method of claim 1, wherein the information is obtained from a plurality of sources including data sources external to the enterprise.

7. The method of claim 1, wherein the step of obtaining information includes transforming the information by categorizing and sorting the information and transforming the information to a predetermined data format.

8. The method of claim 7, wherein the information is obtained and stored using one or more of an SQL call and formatted and unformatted data calls from formatted and unformatted datasets.

9. The method of claim 1, wherein the information is received from an automated data exchange that provides portions of the information from one or more data sources.

10. A method for analyzing security threats in an enterprise, wherein the method is implemented in a computer system comprising one or more processors configured to execute one or more computer program modules, the method comprising:
executing, on the one or more processors of the computer system, one or more computer program modules configured to obtain information associated with a malware risk to an enterprise system;
executing, on the one or more processors of the computer system, one or more computer program modules configured to provide assurance threat analysis intelligence corresponding to the information by determining relationships between portions of the information; and
executing, on the one or more processors of the computer system, one or more computer program modules configured to generate a visualization of threats to the enterprise system based on the intelligence an the results from performed analytics on the information and the intelligence,
wherein the visualization includes a display of one or more reports.

11. The method of claim 10, wherein the enterprise system comprises one or more information technology materials tracking systems.

12. The method of claim 10, wherein the enterprise system comprises a sourcing system.

13. The method of claim 10, wherein the enterprise system comprises a purchasing system.

14. The method of claim 10, wherein the enterprise system comprises an inventory control system.

15. The method of claim 10, wherein the information is obtained from a plurality of sources including data sources external to the enterprise.

16. The method of claim 10, wherein the step of obtaining information includes transforming the information by categorizing and sorting the information and transforming the information to a predetermined data format.

17. The method of claim 16, wherein the information is obtained and stored using one or more of an SQL call and formatted and unformatted data calls from formatted and unformatted datasets.

18. The method of claim 10, wherein the information is received from an automated data exchange that provides portions of the information from one or more data sources.
